(19) United States
(12) Patent Application Publication
(10) Pub. No.: US 2007/0194145 A1
(43) Pub. Date: Aug. 23, 2007

(54) APPARATUS OF THINNING A GLASS SUBSTRATE

(76) Inventors: Gi-Won Lee, Suwon-si (KR); Seung-Ju Choi, Ansan-si (KR); Kwang-Ju Sung, Ansan-si (KR)

Correspondence Address: DALY, CROWLEY, MOFFORD & DURKEE, LLP, SUITE 301A, 354A TURNPIKE STREET, CANTON, MA, 02021-2714, US

(21) Appl. No.: 11/674,214

(22) Filed: Feb. 13, 2007

(30) Foreign Application Priority Data
Feb. 17, 2006 (KR) 2006-15642

(51) Int. Cl. B05B 9/00

(52) U.S. Cl. 239/124

(57) ABSTRACT

An apparatus of thinning a glass substrate includes at least one chemical spray member, a chemical supply member, and a bath. The chemical spray member includes a first tube and a second tube enclosing the first tube. The first tube has a plurality of first spray holes disposed along a first direction. The second tube has at least one second spray hole disposed at a lateral portion of the second tube along a second direction. The chemical supply member includes a connection tube and a press pump. The connection tube is coupled to the chemical spray member, and the press pump is disposed at an end portion of the connection tube. The bath includes a chemical receiving member for storing chemicals and a fence disposed on the chemical receiving member. The fence receives the chemical spray member.

### CROSS-REFERENCE TO RELATED APPLICATION

This application claims priority under 35 USC §119 to Korean Patent Application No. 2006-15642 filed on Feb. 17, 2006, the contents of which are incorporated herein by reference in their entirety.

### BACKGROUND OF THE INVENTION

1. Field of the Invention

Example embodiments of the present invention relate to an apparatus of thinning a glass substrate. More particularly, example embodiments of the present invention relate to an apparatus of thinning a glass substrate for a flat panel display device.

2. Description of the Related Art

Flat panel devices such as a liquid crystal display (LCD) device, a plasma display panel (PDP) device, an electroluminescent display (ELD) device and a vacuum fluorescent display (VFD) device usually include a glass substrate of silicon oxide. Since an entire weight of the flat panel display device is determined by a weight of the glass substrate, the weight of the glass substrate is continuously reduced so as to obtain the flat panel display device having a light weight.

Generally, the weight of the glass substrate for the flat panel display device is reduced by thinning a thickness of the glass substrate. As for a glass substrate used in the LCD device, a thickness of the glass substrate may be decreased from about 1.2 mm to about 0.8 mm. Recently, the glass substrate for the LCD device has a very thin thickness below about 0.6 mm.

In a process for thinning the glass substrate, a processed glass substrate should have a thin and uniform thickness because the flat panel display device including the processed glass substrate may have a poor display quality when the processed glass substrate has an irregular surface.

In one conventional method of thinning a glass substrate, the glass substrate is immersed into chemicals stored in a bath, and then the glass substrate is etched by the chemicals. However, the glass substrate may not have a desired uniform thickness because the glass substrate is etched while immersing the glass substrate in the chemicals.

According to another conventional method of thinning a glass substrate, a bubbler or a spray nozzle is provided on a bottom face of a bath, and then chemicals are bubbled or sprayed toward the glass substrate that is vertically disposed in the bath. The glass substrate may have a uniform thickness, however, reaction by-products generated by a reaction between the chemicals and the glass substrate may be frequently attached to the glass substrate. When the reaction by-products are attached to the glass substrate, a failure of the glass substrate may be caused and a flat panel display device including such glass substrate may have deteriorated characteristics such as a poor display quality, a low reliability, a reduced life time, etc.

### SUMMARY OF THE INVENTION

Example embodiments of the present invention provide an apparatus of thinning a glass substrate capable of obtaining a glass substrate having a desirably uniform and thin thickness while preventing reaction by-products from being attached to the glass substrate.

According to one aspect of the present invention, there is provided an apparatus of thinning a glass substrate including at least one chemical spray member, a chemical supply member, and a bath. The chemical spray member includes a first tube and a second tube enclosing the first tube. The first tube has a plurality of first spray holes disposed along a first direction. The second tube has at least one second spray hole disposed at a lateral portion of the second tube along a second direction. The chemical supply member includes a connection tube and a press pump. The connection tube is coupled to the chemical spray member, and the press pump is disposed at an end portion of the connection tube. The bath includes a chemical receiving member for storing chemicals, and a fence disposed on the chemical receiving member. The fence receives the chemical spray member. The chemicals are uniformly sprayed on an entire face of at least one glass substrate disposed in the fence using the press pump to remove reaction by-products attached on the glass substrate while thinning the glass substrate. The chemicals sprayed on the glass substrate are collected by the chemical receiving member.

In example embodiments of the present invention, the first direction may be substantially parallel to a lengthwise direction of the first tube. Additionally, the first direction may be substantially parallel to the second direction.

In example embodiments of the present invention, the first tube may have a substantially circular cross-section or a substantially elliptical cross-section, and the second tube may have a polygonal cross-section.

In example embodiments of the present invention, an outer face of the first tube may make contact with an inner face of the second tube.

In example embodiments of the present invention, the connection tube may include a flexible tube having a variable length, and the chemical spray member may move along a vertical direction and/or a horizontal direction in accordance with a variation in a length of the connection tube.

In an example embodiment of the present invention, the second tube may include one second spray hole disposed at one lateral portion of the second tube, and the apparatus may include two chemical spray members disposed near upper and lower faces of the glass substrate. The first spray holes of the first tube may be disposed toward the second spray hole of the second tube.

In an example embodiment of the present invention, the second tube may include two second spray holes disposed at opposed lateral portions of the second tube, and two glass substrates may be disposed near the second spray holes, respectively. The first holes may be uniformly disposed by a predetermined interval.

In example embodiments of the present invention, the chemicals may include fluoride salt such as ammonium bifluoride (NH₄HF₂).

According to another aspect of the present invention, there is provided an apparatus of thinning a glass substrate including at least one air spray member and at least one chemical supply member. The air spray member includes a first tube and a second tube. The first tube has a plurality of first spray holes disposed along a first direction, and the second tube has at least one second spray hole disposed through at least one lateral portion of the second tube along a second direction. The chemicals supply member is disposed near a lateral face of a glass substrate. Chemicals provided from the chemicals supply member downwardly flow on an upper face and a lower face of the glass substrate, and an air is provided from the air spray member onto the upper and the lower faces of the glass substrate so as to remove reaction by-products from the glass substrate while thinning the glass substrate.

In example embodiments of the present invention, the air spray member may move along a vertical direction with respect to the glass substrate.

In example embodiments of the present invention, the air spray member may be perpendicularly disposed with respect to the chemical supply member.

In example embodiments of the present invention, two air spray members may be provided near the upper and the lower faces of the glass substrate. Here, two chemical supply members may be provided near one lateral face of the glass substrate.

According to the present invention, reaction by-products may be removed from the glass substrate while thinning the glass substrate using the apparatus of thinning a glass substrate. Therefore, the glass substrate desirably may have a uniform and thin thickness by preventing the reaction by-products from being attached to the glass substrate. As a result, the glass substrate is well employed in a flat panel display devices such as an LDC device, a PDP device, an ELD device, a VFD device, etc.

### BRIEF DESCRIPTION OF THE DRAWINGS

The above and other features and advantages of the present invention will become readily apparent by reference to the following detailed description when considered in conjunction with the accompanying drawings wherein:

FIG. 1 is a perspective view illustrating an apparatus of thinning a glass substrate in accordance with example embodiments of the present invention;

FIG. 2 is a cross-sectional view illustrating a chemical spray member of the apparatus of thinning a glass substrate in FIG. 1;

FIG. 3 is an enlarged perspective view illustrating a first tube of the chemical spray member in FIG. 2;

FIG. 4 is a cross-sectional view illustrating a chemical spray member of an apparatus of thinning a glass substrate in accordance with example embodiments of the present invention; and

FIG. 5 is a cross-sectional view illustrating an apparatus of thinning a glass substrate in accordance with example embodiments of the present invention.

### DESCRIPTION OF THE EMBODIMENTS

The present invention is described more fully hereinafter with reference to the accompanying drawings, in which example embodiments of the present invention are shown. The present invention may, however, be embodied in many different forms and should not be construed as limited to the example embodiments set forth herein. Rather, these example embodiments are provided so that this disclosure will be thorough and complete, and will fully convey the scope of the present invention to those skilled in the art. In the drawings, the sizes and relative sizes of layers, patterns and regions may be exaggerated for clarity.

It will be understood that when an element or a layer is referred to as being “on,” “connected to” or “coupled to” another element or another layer, it can be directly on, connected or coupled to the other element, the other layer or intervening elements or layers may be present. In contrast, when an element is referred to as being “directly on,” “directly connected to” or “directly coupled to” another element or another layer, there are no intervening elements or layers present. Like reference numerals refer to like elements throughout. As used herein, the term “and/or” includes any and all combinations of one or more of the associated listed items.

It will be understood that, although the terms first, second, third etc. may be used herein to describe various elements, components, regions, patterns, layers and/or sections, these elements, components, regions, patterns, layers and/or sections should not be limited by these terms. These terms are only used to distinguish one element, component, region, pattern, layer or section from another region, layer or section. Thus, a first element, component, region, pattern, layer or section discussed below could be termed a second element, component, region, pattern, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components and/or groups thereof.

Example embodiments of the present invention are described herein with reference to cross-sectional illustrations that are schematic illustrations of idealized embodiments (and intermediate structures) of the present invention. As such, variations from the shapes of the illustrations as a result, for example, of manufacturing techniques and/or tolerances, are to be expected. Thus, example embodiments of the present invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

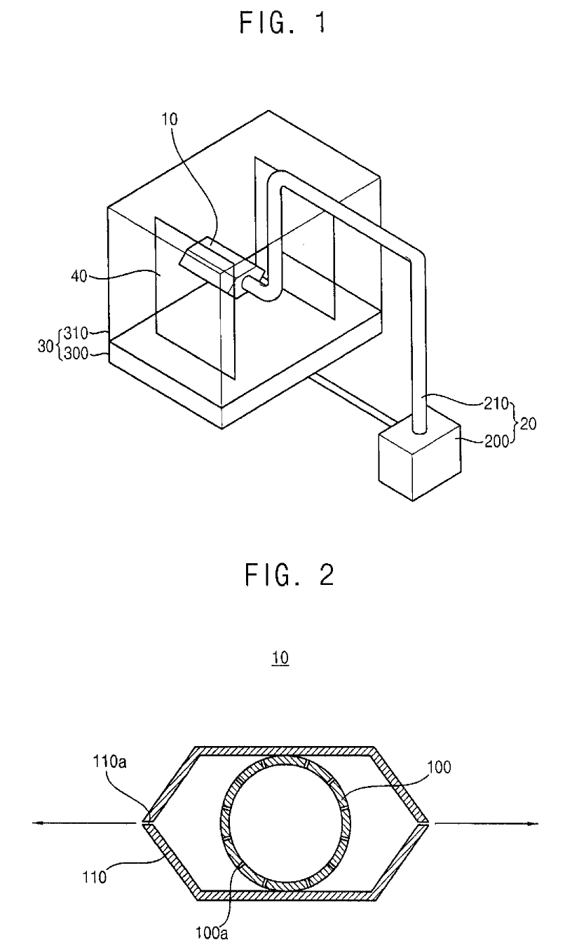

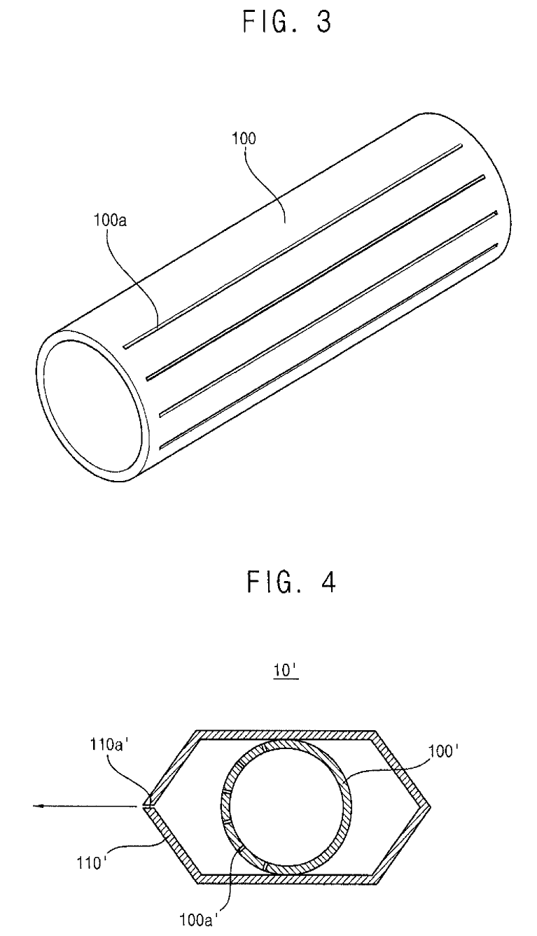

FIG. 1 is a perspective view illustrating an apparatus of thinning a glass substrate in accordance with example embodiments of the present invention. FIG. 2 is a cross-sectional view illustrating a chemical spray member of the apparatus of thinning a glass substrate in FIG. 1. FIG. 3 is an enlarged perspective view illustrating a first tube of the chemical spray member in FIG. 2.

Referring to FIGS. 1 and 2, the apparatus of thinning a glass substrate includes a chemical spray member 10. The chemical spray member 10 includes a first tube 100 and a second tube 110.

Referring to FIGS. 2 and 3, the first tube 100 of the chemical spray member 10 includes a plurality of first spray holes 100a, and the second tube 110 of the chemical spray member 10 includes at least one second spray hole 110a.

The first tube 100 is installed in the second tube 110. Thus, the first tube 100 may correspond to an inner tube, whereas the second tube may correspond to an outer tube enclosing the inner tube. In some example embodiments, the first tube 100 may have a circular cross-section, an elliptical cross-section or any other suitable cross-sections. The second tube 110 may have a polygonal cross-section such as a hexagonal cross-section. An outer circumferential face of the first tube 100 may make contact with an inner face of the second tube 110. For example, two contact points may be disposed between the outer circumferential face of the first tube 100 and the inner face of the second tube 110.

The chemical spray member 10 may have a length varied in accordance with conditions of a glass substrate 40 and/or dimensions of the apparatus of thinning a glass substrate. In example embodiments, the chemical spray member 10 may have a length substantially the same as a length of the glass substrate 40 while thinning the glass substrate 40. When a length of the chemical spray member 10 is shorter than that of the glass substrate 40, chemicals may not be uniformly sprayed onto an entire face of the glass substrate 40. When the chemical spray member 10 has a length longer than that of the glass substrate 40, an efficiency of the apparatus of thinning a glass substrate may be deteriorated.

In some example embodiments of the present invention, the first spray holes 100a of the first tube 100 are disposed along a first direction. The first direction may be substantially in parallel to a lengthwise direction of the first tube 100. Two second spray holes 110a are disposed at corresponding lateral portions of the second tube 110. The second spray holes 110a may extend along a second direction substantially parallel to the first direction. That is, the second spray holes 110a may have line shapes extending through opposed lateral portions of the second tube 110. The second spray holes 110a of the second tube 110 may be positioned so as to vertically spray the chemicals onto the glass substrate 40. When the second spray holes 110a are formed through both lateral portions of the second tube 110, the first spray holes 100a may be uniformly disposed by a predetermined interval.

In some example embodiments of the present invention, the chemicals may be uniformly provided onto the entire face of the glass substrate 40 because of a specific configuration of the chemical spray member 10. Particularly, since the first tube 100 including the plurality of first spray holes 100a is disposed in the second tube 110 and the second tube 110 includes the second spray holes 110a having the line shapes, the chemicals may be uniformly sprayed onto the entire face of the glass substrate 40 while thinning the glass substrate 40.

FIG. 4 is a cross-sectional view illustrating a chemical spray member of an apparatus of thinning a glass substrate in accordance with example embodiments of the present invention.

Referring to FIG. 4, a chemical spray member 10′ includes a first tube 100′ having a plurality of first spray holes 100a′, and a second tube 110′ having one second spray hole 110a′.

The first tube 100′ is disposed in the second tube 110′. The first and the second tubes 100′ and 110′ may have configurations substantially the same as those of the first and the second tubes 100 and 110 shown in FIG. 2.

The second spray hole 110a′ may be disposed at one lateral portion of the second tube 110′. The second spray holes 110a′ may face with a glass substrate. The first spray holes 100a′ may also be formed at one lateral portion of the first tube 100′. The first spray holes 100a′ of the first tube 100′ may be disposed toward the second spray hole 110a′ of the second tube 110′. For example, the first spray holes 100a′ may be uniformly positioned at one lateral portion of the first tube 100′ by a predetermined interval. In some example embodiments, the apparatus of thinning a glass substrate may include a plurality of chemical spray members. Here, each of second spray holes of second tubes in the chemical spray members may be positioned toward an entire face of the glass substrate.

In some example embodiments of the present invention, as shown in FIG. 2, two glass substrates may be disposed near both lateral portions of one chemical spray member when chemicals are provided from both lateral portions of the chemical spray member.

In some example embodiments of the present invention, as shown in FIG. 4, two chemical spray members may be disposed near an upper face and a lower face of a glass substrate when chemicals are sprayed from each lateral portion of the chemical spray members, respectively.

Referring now to FIG. 1, the apparatus of thinning a glass substrate further includes a chemical supply member 20. The chemical supply member 20 includes a connection tube 210 and a press pump 200.

The connection tube 210 is coupled to the chemical spray member 10, and the press pump 200 is connected to an end portion of the connection tube 210. In some example embodiments, the connection tube 210 may include a flexible tube having a variable length. That is, a length of the connection tube 210 may be properly adjusted in accordance with a movement of the chemical spray tube 10. For example, the length of the connection tube 210 may be increased or decreased while moving the chemical spray member 10 along a vertical direction or a horizontal direction in a process for thinning the glass substrate 40. That is, the chemical spray member 10 may be moved up and down, or left and right in accordance with a variation in the length of the connection tube 210.

The press pump 200 of the chemical supply member 20 pressurizes the chemicals, and then provides the pressurized chemicals into the chemical spray member 10 through the connection tube 210. When the pressurized chemicals are provided onto the entire face of the glass substrate 40, the process for thinning the glass substrate 40 may be effectively carried out.

The apparatus of thinning a glass substrate may include a transfer member (not shown) for moving the glass substrate 40 in the vertical direction and/or the horizontal direction. That is, the glass substrate 40 may be moved up and down, and/or left and right by the transfer member while thinning the glass substrate 40.

In some example embodiments of the present invention, at least one chemical spray member 10 may move in the vertical direction and/or the horizontal direction with respect to at least one glass substrate 40 while fixing the glass substrate 40 near the chemical spray member 10. Alternatively, at least one glass substrate 40 may move along the vertical direction and/or the horizontal direction relative to at least one chemical spray member 10 while fixing the chemical spray member 10 near the glass substrate 40.

As shown in FIG. 1, the apparatus of thinning a glass substrate additionally include a bath 30 having a chemical receiving member 300 and a fence 310.

The chemical receiving member 300 is coupled to the chemical supply member 20. The chemicals stored in the chemical receiving member 300 may be provided into the chemical spray member 10 through the chemical supply member 20. The fence 310 is disposed on a peripheral portion of the chemical receiving member 300. The chemical spray member 10 is installed in the fence 310.

In the process for thinning the glass substrate 40, the chemical spray member 10 may uniformly provide the entire face of the glass substrate 40 positioned in the fence 310 of the bath 30 with the chemicals pressurized by the press pump 200 through the connection tube 210 of the chemical supply member 20. Therefore, the glass substrate 40 may have a thin and uniform thickness while effectively removing reaction by-products from the glass substrate 40.

In some example embodiments of the present invention, the chemicals provided on the glass substrate 40 may be collected in the chemical receiving member 300 of the bath 30 after spraying the chemicals onto the glass substrate 40. Thus, an amount of the chemicals may be considerably reduced in the process for thinning the glass substrate 40. When the reaction by-products are included in the collected chemicals, the apparatus of thinning a glass substrate may include a filter member (not shown) for purifying the collected chemicals. The filter member may be installed between the bath 30 and the chemical supply member 20 or between the chemical supply member 20 and the chemical spray member 10.

While the chemicals are stored in the fence 310, the process for thinning the glass substrate 40 may be performed. That is, the glass substrate 40 may be immersed in the chemicals received by the fence 310, and then the chemicals may be additionally sprayed onto the entire face of the glass substrate 40 through the chemical spray member 10. When the process for thinning the glass substrate 40 is performed while immersing the glass substrate 40 in the chemicals stored in the fence 310, the glass substrate 40 may be more stably processed because the chemicals in the fence 310 may provide the glass substrate 40 with buoyancy.

In some example embodiments of the present invention, the chemicals may include a fluoride salt such as ammonium bifloride (NH₄HF₂). When the chemicals include the fluoride salt, an amount of a precipitate in the collected chemicals may be advantageously reduced.

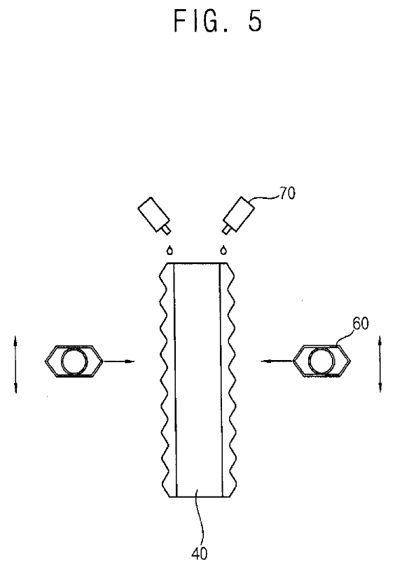

FIG. 5 is a cross-sectional view illustrating an apparatus of thinning a glass substrate in accordance with example embodiments of the present invention.

Referring to FIG. 5, the apparatus of thinning a glass substrate includes at least one air spray member 60. The air spray member 60 may have a configuration substantially the same as that of the chemical spray member 10 shown in FIG. 2 or the chemical spray member 10 shown in FIG. 4. The air spray member 60 may spray an air onto a glass substrate 40 instead of the chemicals.

The air spray member 40 includes a first tube having a plurality of first spray holes, and a second tube having at least one second spray hole. The first spray holes may extend along a direction substantially parallel to a lengthwise direction of the first tube. The second spray hole may be disposed at a lateral portion of the second tube. As described above, the second spray hole may have a line shape.

In some example embodiments of the present invention, the apparatus of thinning a glass substrate further includes at least one chemical supply member 70 besides the air spray member 60. For example, two chemical supply members 70 may be disposed near an upper face and a lower face of the glass substrate 40. Chemicals provided from the chemical supply members 70 may flow downwardly onto the upper and the lower faces of the glass substrate 40.

In some example embodiments of the present invention, two air spray members 60 may be perpendicularly disposed relative to two chemical supply members 70, respectively. For example, the air spray members 60 may be perpendicularly positioned relative to the upper and the lower faces of the glass substrate 40, whereas the chemical supply members 70 may be perpendicularly disposed with respect to one lateral face of the glass substrate 40.

In one example embodiment of the present invention, the air spray member 60 may move along a vertical direction relative to the glass substrate 40 as shown in FIG. 5. Alternatively, the air spray member 60 may move along a horizontal direction with respect to the glass substrate 40. That is, the air spray member 60 may be moved up and down, or left and right with respect to the glass substrate 40 while thinning the glass substrate 40. Here, the glass substrate 40 may be fixed while moving the air spray member 60.

In another example embodiment of the present invention, the glass substrate 40 may move along the vertical direction or the horizontal direction relative to the air spray member 60 while fixing the air spray member 60.

In still another example embodiment of the present invention, the glass substrate 40 and the air spray member 60 may move relative to each other while thinning the glass substrate 40.

When the chemicals are provided onto the glass substrate 40 from the at least one chemical supply member 70 and the air is sprayed onto the glass substrate 40 from the at least one air spray member 60, the glass substrate 40 may have a uniform and thin thickness while effectively removing reaction by-products from the glass substrate 40.

In some example embodiments of the present invention, the air spray member 60 may provide the glass substrate 40 with chemicals instead of the air.

As described above, the chemicals may include a fluoride salt such as ammonium bifloride (NH₄HF₂) so that an amount of a precipitate in the collected chemicals may be advantageously reduced.

According to the present invention, an apparatus of thinning a glass substrate may provide a glass substrate having a desirably thin and uniform thickness. Additionally, reaction by-products may not be attached to the glass substrate in a process for thinning the glass substrate when the reaction by-products may be generated by reaction between chemicals and the glass substrate. Thus, a failure of the glass substrate caused by the reaction by-products may be effectively prevented. Further, the glass substrate having the thin and uniform thickness may be advantageously employed for a flat panel display device so as to ensure a high quality of the flat panel display device.

The foregoing is illustrative of the present invention and is not to be construed as limiting thereof. Although a few example embodiments of the present invention have been described, those skilled in the art will readily appreciate that many modifications are possible in the example embodiments without materially departing from the novel teachings and advantages of this invention. Accordingly, all such modifications are intended to be included within the scope of the present invention as defined in the claims. In the claims, means-plus-function clauses are intended to cover the structures described herein as performing the recited function and not only structural equivalents but also equivalent structures. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The present invention is defined by the following claims, with equivalents of the claims to be included therein.

What is claimed is:

1. An apparatus of thinning a glass substrate, comprising:
at least one chemical spray member including a first tube and a second tube enclosing the first tube, the first tube having a plurality of first spray holes disposed along a first direction, the second tube having at least one second spray hole disposed at a lateral portion of the second tube along a second direction;
a chemical supply member including a connection tube and a press pump, the connection tube being coupled to the chemical spray member, the press pump being disposed at an end portion of the connection tube; and
a bath including a chemical receiving member for storing chemicals and a fence disposed on the chemical receiving member, the fence receiving the chemical spray member,
wherein the chemicals are uniformly sprayed on an entire face of at least one glass substrate disposed in the fence using the press pump to remove reaction by-products attached on the glass substrate while thinning the glass substrate, and the chemicals sprayed on the glass substrate are collected by the chemical receiving member.

2. The apparatus of claim 1, wherein the first direction is substantially parallel to a lengthwise direction of the first tube and the first direction is substantially parallel to the second direction.

3. The apparatus of claim 1, wherein the first tube has a substantially circular cross-section or a substantially elliptical cross-section, and the second tube has a polygonal cross-section.

4. The apparatus of claim 1, wherein an outer face of the first tube makes contact with an inner face of the second tube.

5. The apparatus of claim 1, wherein the connection tube comprises a flexible tube having a variable length, and the chemical spray member moves along a vertical direction and/or a horizontal direction in accordance with a variation in a length of the connection tube.

6. The apparatus of claim 1, wherein the second tube comprises one second spray hole disposed at one lateral portion of the second tube, and the apparatus comprises two chemical spray members disposed near an upper face and a lower face of the glass substrate.

7. The apparatus of claim 1, wherein the first spray holes of the first tube are disposed toward the second spray hole of the second tube.

8. The apparatus of claim 1, wherein the second tube comprises two second spray holes disposed at opposed lateral portions of the second tube, and two glass substrates are disposed near the second spray holes, respectively.

9. The apparatus of claim 8, wherein the first holes are uniformly disposed by a predetermined interval.

10. The apparatus of claim 1, wherein the chemicals comprise fluoride salt.

11. An apparatus of thinning a glass substrate, comprising:
at least one air spray member including a first tube and a second tube, the first tube having a plurality of first spray holes disposed along a first direction, the second tube having at least one second spray hole disposed through at least one lateral portion of the second tube along a second direction; and
at least one chemical supply member disposed near a lateral face of a glass substrate,
wherein chemicals provided from the chemical supply member flow downwardly onto an upper face and a lower face of the glass substrate, and an air is provided from the air spray member onto the upper and the lower faces of the glass substrate to remove reaction by-products from the glass substrate while thinning the glass substrate.

12. The apparatus of claim 11, wherein the air spray member moves along a vertical direction with respect to the glass substrate.

13. The apparatus of claim 11, wherein the air spray member is perpendicularly disposed with respect to the chemical supply member.

14. The apparatus of claim 11, wherein two air spray members are provided near the upper and the lower faces of the glass substrate.

15. The apparatus of claim 14, wherein two chemical supply members are provided near one lateral face of the glass substrate.
